(19) United States
(12) Patent Application Publication
(10) Pub. No.: US 2010/0214084 A1
(43) Pub. Date: Aug. 26, 2010

(54) VEHICLE IMMOBILIZER

(76) Inventor: Thomas E. Haste, III, Gainesville, FL (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/850,131

(22) Filed: Sep. 5, 2007

(51) Int. Cl. B60R 25/10

(52) U.S. Cl. 340/426.11

(57) ABSTRACT

A vehicle immobilization apparatus may be temporarily secured to a vehicle and may be subsequently activated to disable the vehicle. Upon activation, the apparatus generates an electromagnetic signal to disrupt the vehicle's electronic devices, particularly the engine management control system. The apparatus is mechanically secured to the vehicle by magnets, a suction device or other suitable means.

### BACKGROUND OF THE INVENTION

1. Field of the Invention

The present invention relates to the field of police enforcement and, more specifically, to an apparatus for immobilizing a motor vehicle to prevent it from becoming involved in a high speed chase.

2. Background of the Invention

Police pursuits of fleeing vehicles have become an all too common occurrence. Such pursuits consume valuable resources and endanger the public. Various tactics have been developed to terminate pursuits once they have begun. These include the deployments of “spike strips” and other vehicle immobilization devices and the tactical use of pursuing vehicles to stop the fleeing vehicle, e.g., the pursuit intervention technique or “PIT” maneuver.

A number of prior art patents have addressed immobilization of fleeing vehicles. Many of these require that a device be hard-wired into a vehicle's electrical system. Some employ electrical disruption of the vehicle's electronic systems without the need for a receiving device in the vehicle. For example, U.S. Pat. No. 5,293,527 discloses a transportable electromagnetic pulse (EMP) generator with an antenna that can be aimed at a target vehicle. U.S. Pat. No. 5,503,059 discloses a rocket-propelled sled with an EMP generator that can be deployed under a fleeing vehicle. U.S. Pat. No. 5,952,600 discloses a weapon for disabling the engine of a vehicle by transmitting high frequency electrical impulses to the vehicle by means of one or two electrically conductive channels of ionized air produced within one or two laser beams aimed at the vehicle. U.S. Pat. No. 6,371,000 discloses an electronic vehicle disabler that delivers an electrical current to the vehicle. The current path is coupled to the vehicle through conductive linkages that are temporarily or permanently laid down on a roadway over which the vehicle passes, or that are coupled to the vehicle from a pursuing vehicle. The electrical current is delivered by electrically conductive wires or electrically conductive streams of fluid or gas. U.S. Pat. No. 6,723,225 discloses a vehicle disabling device that delivers a pulse of electric energy from a platform at a fixed location in the path of the vehicle or from a mobile platform such as a helicopter. The electrical pulse is delivered by streams of electrolyte fluid. U.S. Pat. No. 7,111,559 discloses a projectile for disabling a moving vehicle. The projectile penetrates the body of the vehicle and generates an electric current for inducing a short circuit, thereby disabling an electronic control module of the vehicle.

In many situations, a police pursuit begins after a vehicle has been stopped by a police officer for a traffic infraction or for some other reason. In such situations, the police officer is afforded the opportunity to prevent a pursuit before it even begins. Thus, there is a need for an apparatus that can be placed on or near a stopped vehicle and that can be subsequently activated to immobilize the vehicle should the driver attempt to flee the scene.

### SUMMARY OF THE INVENTION

The present invention provides a vehicle immobilization apparatus that may be temporarily secured to a vehicle and that may be subsequently activated to disable the vehicle. Upon activation, the apparatus generates an electromagnetic signal to disrupt the vehicle's electronic devices, particularly the engine management control system. The apparatus is mechanically secured to the vehicle by magnets, a suction device or other suitable means.

### BRIEF DESCRIPTION OF THE DRAWINGS

FIG. 1 illustrates a vehicle immobilization apparatus according to an embodiment of the present invention secured to a vehicle.

FIG. 2 is a functional block diagram of a vehicle immobilization apparatus according to an embodiment of the present invention.

FIG. 3 is a functional block diagram of a vehicle immobilization apparatus according to another embodiment of the present invention.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

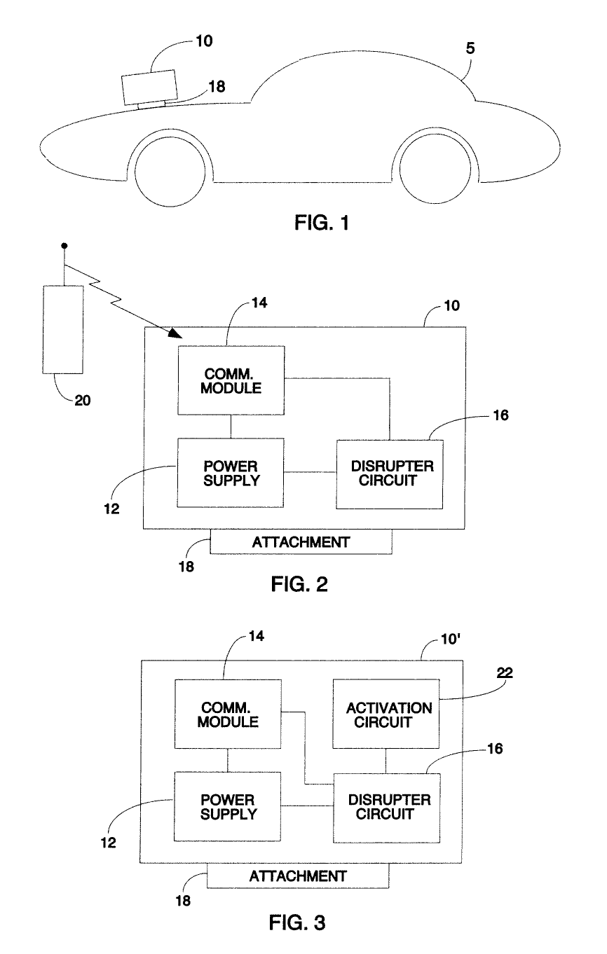

FIG. 1 illustrates a vehicle immobilization apparatus 10 that has been secured to a vehicle 5. Apparatus 10 may be housed within a suitable enclosure for ease of handling and attachment to a vehicle. The apparatus may be secured on or near the vehicle's engine compartment. Depending upon the configuration of the vehicle, it may be desirable to secure the apparatus in another location that is proximate to the vehicle's engine control electronics. Apparatus 10 may be secured to the vehicle magnetically; however, other attachment means such as a suction device or an adhesive may be used, particularly for vehicles with aluminum or plastic body panels.

Apparatus 10 is preferably carried in a police vehicle for use by a police officer when stopping another vehicle for a traffic infraction or for some other reason. Immediately upon approaching the stopped vehicle, the police officer can secure the apparatus to the vehicle before the driver of the vehicle has an opportunity to flee the scene. While being carried in the police vehicle, apparatus 10 is preferably “docked” with a connection to the vehicle's electrical system to keep the apparatus' power supply fully charged.

FIG. 2 is functional block diagram of apparatus 10. A power supply 12 provides electrical power to communications module 14 and to disrupter circuit 16. Communications module 14 comprises a receiver for receiving an activation signal from a remote transmitter 20. Upon receiving the activation signal, the communications module provides an enable signal to disrupter circuit 16.

Disrupter circuit 16 generates an electromagnetic signal to disable electronic components of the vehicle to which apparatus 10 is attached. The signal may be an electromagnetic pulse (EMP) or another signal with suitable characteristics for disabling the electronic components of the vehicle. In this regard, certain of the vehicle's electronic components may be designed to be disabled in the presence of the signal generated by the disrupter circuit. The disrupter circuit may be armed upon removal of apparatus 10 from a police vehicle or may incorporate an arming switch or circuit operated by the police officer.

As discussed above, attachment means 18 may comprise one or more magnets. Alternatively, a suction device or an adhesive may be used to secure apparatus 10 to a vehicle. Attachment means 18 may comprise a combination of such attachment methods for ease of attachment to a variety of vehicle types.

FIG. 3 is a functional block diagram of an apparatus 10′, which is a modification of the above-described apparatus 10. In this embodiment, the apparatus further includes an activation circuit 22. Once the apparatus is armed by the police officer, either upon removal of the apparatus from the police vehicle or by means of an arming switch or circuit, the disrupter circuit will be automatically enabled if the apparatus is carried beyond a predetermined distance from either the police vehicle or the remote control carried by the police officer. This insures that the suspect vehicle will be immobilized if it flees the scene while the police officer is unable to transmit the activation signal for any reason.

In another variation, the activation circuit may comprise a timing circuit that enables the disrupter circuit after a predetermined period of time. Thus, for example, if the police officer is incapacitated, the suspect vehicle will be automatically immobilized. In most circumstances, however, apparatus 10 will be removed from the suspect vehicle before the timer circuit has run out, and the disrupter circuit will be disarmed by reversing the arming procedure. At the same time, the timer circuit will be reinitialized. The timer circuit provides a fail safe mode of operation if the apparatus has received neither an activation signal nor a disarming signal within a predetermined period of time.

In addition to the above-described features, the vehicle immobilization apparatus may incorporate a global positioning system (GPS) device to track the apparatus in the event of malfunction of the disrupter circuit or in the event that the apparatus is carried away from the scene for some other reason. The GPS circuit allows the police officer or the central police office to track the suspect vehicle. The apparatus may also include a transmitter to signal the central police office that is has been armed or activated so that appropriate backup resources may be dispatched. Circuitry within the apparatus may store the time and date of any activation of the disrupter circuit or otherwise store a log of the state of the apparatus for use in subsequent police investigation or court proceedings.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A vehicle immobilization apparatus comprising:
a power supply;
a disrupter circuit for generating an electromagnetic signal adapted to disable electronic components of a vehicle;
an activation circuit for enabling the disrupter circuit;
means for securing the apparatus to an exterior surface of a vehicle.

2. The vehicle immobilization apparatus of claim 1 wherein the electromagnetic signal comprises an electromagnetic pulse.

3. The vehicle immobilization apparatus of claim 1 wherein the attachment means comprises a magnet.

4. The vehicle immobilization apparatus of claim 1 wherein the attachment means comprises a suction device.

5. The vehicle immobilization apparatus of claim 1 wherein the attachment means comprises an adhesive.

6. The vehicle immobilization apparatus of claim 1 further comprising a communications module coupled to the disrupter circuit for receiving a remotely generated activation signal and for enabling the disrupter circuit in response thereto.

7. The vehicle immobilization apparatus of claim 1 wherein the activation circuit comprises circuitry for determining when the apparatus has been moved beyond a predetermined range.

8. The vehicle immobilization apparatus of claim 1 wherein the activation circuit comprises a timer.

9. A vehicle immobilization apparatus comprising:
a power supply;
a disrupter circuit for generating an electromagnetic signal adapted to disable electronic components of a vehicle;
a communications module coupled to the disrupter circuit for receiving a remotely generated activation signal and for enabling the disrupter circuit in response thereto;
means for securing the apparatus to an exterior surface of a vehicle.

10. The vehicle immobilization apparatus of claim 9 further comprising an activation circuit for enabling the disrupter circuit.

11. The vehicle immobilization apparatus of claim 10 wherein the activation circuit comprises circuitry for determining when the apparatus has been moved beyond a predetermined range.

12. The vehicle immobilization apparatus of claim 10 wherein the activation circuit comprises a timer.

13. The vehicle immobilization apparatus of claim 9 wherein the electromagnetic signal comprises an electromagnetic pulse.

14. The vehicle immobilization apparatus of claim 9 wherein the attachment means comprises a magnet.

15. The vehicle immobilization apparatus of claim 9 wherein the attachment means comprises a suction device.

16. The vehicle immobilization apparatus of claim 9 wherein the attachment means comprises an adhesive.
